(19) United States
(12) Patent Application Publication
(10) Pub. No.: US 2007/0022379 A1
(43) Pub. Date: Jan. 25, 2007

(54) Terminal for displaying distributed picture content

(75) Inventors: Masaki Hara, Yokohama-shi (JP); Tomohiro Kawaguchi, Chigasaki-shi (JP)

Correspondence Address: HARNESS, DICKEY & PIERCE, P.L.C., P.O. BOX 828, BLOOMFIELD HILLS, MI, 48303, US

(73) Assignee: Yamaha Music Foundation, Tokyo (JP)

(21) Appl. No.: 11/489,216

(22) Filed: Jul. 19, 2006

(30) Foreign Application Priority Data
Jul. 19, 2005 (JP) 2005-208035

(51) Int. Cl. G11B 27/00

(52) U.S. Cl. 715/723

(57) ABSTRACT

Terminals 10 operate under the control of a computer program. An instruction made by a reproduction/stop switch BL1 causes a data inputting portion BL2 to input streamed moving picture data in which a plurality of moving picture data sets respectively representative of moving picture items shot from respectively different viewpoints, are combined. The data inputting portion BL2 then writes the input moving picture data into a reproduction buffer BL3 successively. A rendering processing portion BL4 successively converts the moving picture data stored in the reproduction buffer BL3 to rendering data for rendering on a display unit 18, and then successively writes the converted data into a rendering buffer BL5. A display controlling portion BL7 successively retrieves, from the rendering buffer BL5, only rendering data corresponding to a viewpoint selected by a viewpoint switch BL6, and writes the retrieved data into a display buffer BL8 that controls display on the display unit 18. Viewpoints of streamed moving picture items shot from various viewpoints are smoothly switched, and continuity of the moving picture content streamed to the terminals 10 is ensured.

### BACKGROUND OF THE INVENTION

1. Field of the Invention

The present invention relates to a terminal which receives externally distributed picture data and displays, on a display unit, picture content represented by the received picture data. The present invention also relates to a computer program applied to the terminal.

2. Description of the Related Art

In recent years, terminals which receive streamed moving picture data and display, on a display unit, moving picture content represented by the received moving picture data have been emerging. As disclosed in Japanese Patent Laid-Open Publication No. 2002-152684, for example, there is an art for storing, in a DVD, a plurality of moving picture data sets respectively representative of moving picture items shot from respectively different viewpoints, and switching the viewpoints of the moving picture items to be displayed on the display unit in response to an externally provided instruction for switching the viewpoints.

Generally, in a case where a plurality of moving picture items shot from various viewpoints are selectively displayed on a viewpoint basis, each viewpoint has a track to record a moving picture data set representative of a moving picture item, so that an instruction to switch the viewpoints causes switching of the tracks for reproduction of moving picture data, resulting in the switching of the viewpoints displayed on a display unit. When the above scheme is applied to streaming of moving picture content, however, a plurality of moving picture data sets each corresponding to a viewpoint are separately distributed as a plurality of data streams. When the moving picture data sets to be distributed are switched by a server side in response to an instruction to switch viewpoints the immediacy of the switching of viewpoints is impaired. In addition, the switching of viewpoints interrupts reproduction of the moving picture content or loses synchronization. In other words, the continuity of the moving picture content to be reproduced is lost at the switching of viewpoints. Even in a case where a plurality of moving picture data sets are distributed as individual data streams at one time to a terminal which reproduces the data sets, the continuity of the moving picture content to be reproduced is not ensured at the switching of viewpoints due to problems such as buffers of the terminal and band of transmission line.

### SUMMARY OF THE INVENTION

The present invention was accomplished to solve the above-described problems, and an object thereof is to enable terminals, in a case where moving picture data is streamed to the terminals, to ensure the continuity of moving picture content at the switching of viewpoints of moving picture items shot from various viewpoints as well as to facilitate smooth switching of the viewpoints.

In order to achieve the above-described object, it is a feature of the present invention to provide a terminal for receiving externally distributed picture data and displaying, on a display unit, picture content represented by the received picture data, the terminal comprising an inputting portion for inputting streamed moving picture data in which a plurality of moving picture data sets respectively representative of moving picture items shot from respectively different viewpoints are combined; a data converter for successively converting the input moving picture data to rendering data for rendering on the display unit, and temporarily storing the converted data; a viewpoint selector for selecting at least one of the viewpoints; and a display controller for retrieving, from the temporarily stored rendering data, rendering data corresponding to the viewpoint selected by the viewpoint selector, and temporarily storing for use in display on the display unit, thereby displaying picture content corresponding to the rendering data on the selected viewpoint on the display unit.

According to another aspect of the present invention, it is another feature of the present invention to provide a computer program applied to a terminal having a receiving portion for receiving externally distributed picture data, a display portion for displaying picture content represented by the picture data, an instruction inputting portion for inputting a user's instruction, and a memory device, and including a computer portion for executing the computer program, the computer program causing the computer portion to perform the processes of causing the receiving portion to input streamed moving picture data in which a plurality of moving picture data sets respectively representative of moving picture items shot from respectively different viewpoints are combined; successively converting the input moving picture data to rendering data for rendering on the display unit, and writing the converted data into a rendering data storage buffer provided in the memory device; inputting, from the instruction inputting portion, an instruction for selecting at least one of the viewpoints; and retrieving, from the rendering data written into the rendering data storage buffer, rendering data on viewpoint selected by the input instruction, and writing the retrieved rendering data into a display data storage buffer provided in the memory device for use in storing display. data representative of picture content to be displayed on the display unit.

According to the features of the present invention configured as above, when moving picture data in which a plurality of moving picture data sets respectively representative of moving picture items shot from respectively different viewpoints are combined is streamed to a terminal, the streamed moving picture data is successively converted to rendering data for rendering on a display unit and is temporarily stored (i.e., written into a rendering data storage buffer). Then, from the temporarily stored rendering data, rendering data on a selected viewpoint for which an instruction has been input is retrieved to be temporarily stored for display use on a display unit (i.e., written into a display data storage buffer). On the display unit, the rendering data temporarily stored for display use is immediately displayed. Consequently, only by a user's instruction made on the terminal to switch viewpoints of moving picture content to be displayed on the display unit, the present invention achieves smooth switching of the viewpoints to be displayed on the display unit in synchronization between the moving picture items before and after the switching, keeping continuity of the moving picture content.

### BRIEF DESCRIPTION OF THE DRAWINGS

FIG. 1 is a schematic diagram showing the general arrangement of a network system including terminals according to the present invention;

FIGS. 2A and 2B are explanatory drawings illustrating an rendering buffer area and a display buffer area provided in a RAM of the respective terminals shown in FIG. 1;

FIG. 3 is a flowchart of a reproduction program executed by a CPU of the respective terminals shown in FIG. 1;

FIG. 4 is a drawing of a display screen of a display unit shown in FIG. 1; and

FIG. 5 is a functional block diagram of the respective terminals shown in FIG. 1.

### DESCRIPTION OF THE PREFERRED EMBODIMENT

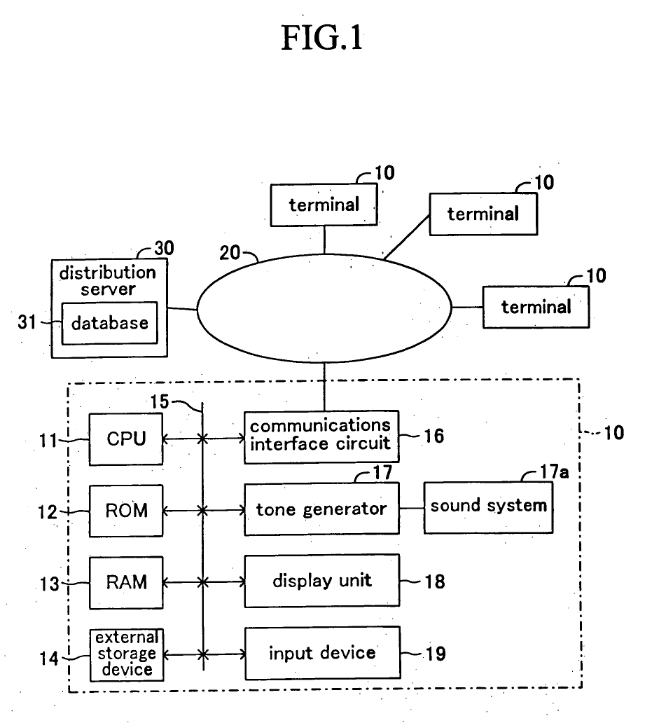

An embodiment of the present invention will now be described with reference to the drawings. Schematically shown in FIG. 1 is a content distribution system including a plurality of terminals 10 according to the present invention. The terminals 10 are a generic name for personal computers, various electronic musical apparatuses including electronic musical instruments, mobile phones, PDAs (portable remote terminals), and the like. The respective terminals 10 are connected to a network 20 such as the Internet, a public switched telephone network, dedicated line or LAN. To the network 20 there is connected a distribution server 30 having a database 31. Stored in the database 31 are various content items to be distributed each including later-described moving picture data. For example, the content items for distribution may include music data for automatic performance of a musical piece (i.e., automatic performance data). In response to a request for distribution of a content item from the terminal 10, the distribution server 30 distributes the requested content item to the terminal 10.

Each set of moving picture data stored in the database 31 is composed of a set of moving picture data in which a plurality of moving picture data sets respectively representative of moving picture items shot from respectively different viewpoints. (angles) are combined. In a set of moving picture data stored in the database 31, more specifically, a plurality of moving picture data sets are combined in parallel as moving picture data representative of a moving picture content item. Represented by the respective sets of moving picture data in one moving picture data set are various moving picture items in which a model performance of a musical instrument such as a wind instrument or piano is simultaneously shot from various viewpoints (angles) (e.g., moving picture items in which the whole body of a player is shot from the front, the sides, etc. and moving picture items in which body parts of the player such as his hands and feet are shot). The parallel combination indicates that pieces of moving picture data representative of a moment (picture data for a plurality of panes) contained in a plurality of moving picture data strings are combined in parallel to form a string of moving picture data (picture data for one pane) representative of every moment. In the present embodiment, two sets of moving picture data (moving picture data sets representative of moving picture items viewed from viewpoints A and B, respectively) are employed as the plurality of moving picture data strings. More specifically, two moving picture data strings are combined to form a moving picture data string, and the combined moving picture data is stored in the database 31.

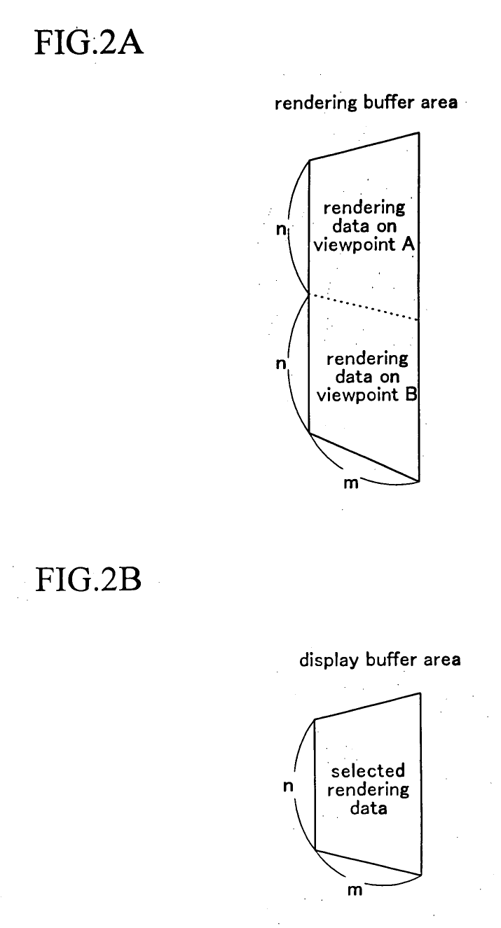

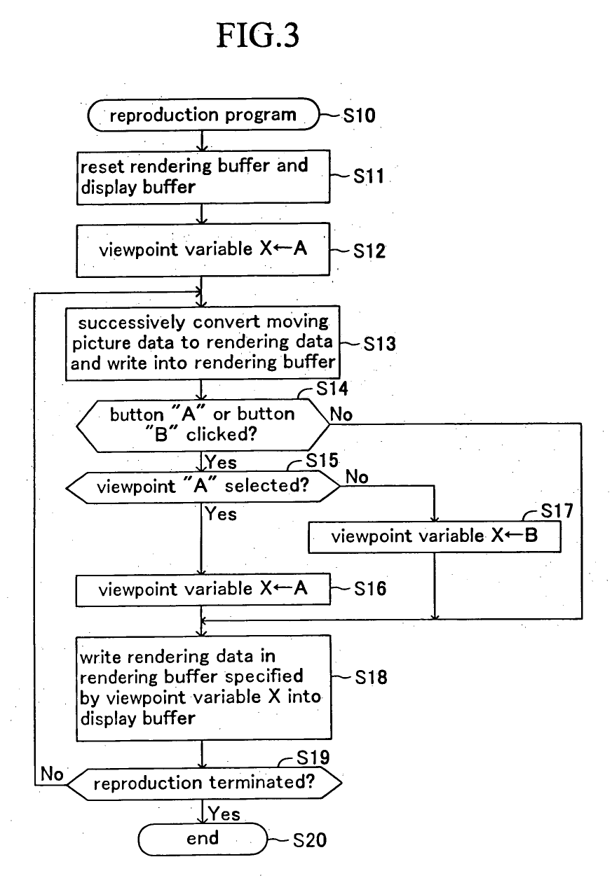

The individual terminals 10 have a CPU 11, a ROM 12, a RAM 13 and an external storage device 14 and the like that compose a computer portion as shown in FIG. 1 which details one of the terminals 10. The CPU 11, ROM 12, RAM 13 and the external storage device 14 are connected to a bus 15. The CPU 11 executes various programs (in the present embodiment, particularly, a reproduction program shown in FIG. 3 which will be described later) to control operation of the terminal 10. The ROM 12 stores firmware. The ROM 12 may be configured by flash memory. The RAM 13 temporarily stores various programs and data for the control of operation of the terminal 10. In the present embodiment, particularly, the RAM 13 is provided with a reproduction buffer area, an rendering buffer area and a display buffer area. The reproduction buffer area is a storage area for temporarily storing, in sequence, content (moving picture data) that the terminal 10 has received. As shown in FIG. 2A, the rendering buffer area is a storage area for temporarily storing two pieces of picture data (picture data for two panes, i.e., picture data for two screens) representative of a given moment contained in two moving picture data strings. The display buffer area is a storage area for temporarily storing, in sequence, picture data for one pane (picture data for one screen) to be displayed on a display unit 18 which will be described later. Picture data for one pane is composed of rendering data (pixel data), the number of the rendering data (pixel data) being m×n. Stored in the rendering buffer area is the rendering data, the number of which being 2×m×n. Stored in the display buffer area is the rendering data, the number of which being m×n.

The external storage device 14 includes various storage media such as hard disk HD previously incorporated in the terminal 10, and compact disk CD and flexible disk FD attachable to the terminal 10. The external storage device 14 also includes drive units for the storage media to enable storing and reading of voluminous data and programs. The data and programs are previously stored in the hard disk HD, supplied from the compact disk CD, flexible disk FD or the like to the hard disk HD or externally supplied through the network 20 via a later-described communications interface circuit 16 to the hard disk HD. In the present embodiment, particularly, the reproduction program shown in FIG. 3 is stored in the hard disk HD. In a case where a flash memory is used as the ROM 12 as described above, programs including the reproduction program may be stored in the ROM 12.

Connected to the bus 15 are the communications interface circuit 16, a tone generator 17, the display unit 18 and an input device 19. The communications interface circuit 16 is connected to the network 20 to enable transmission and reception of various data and programs between the terminal 10 and the distribution server 30 through the network 20. In a case where a mobile phone, PDA and the like is used as the terminal 10, a wireless communication device is incorporated in the communications interface circuit 16 to enable connection with the network 20 via a relay station which is not shown through the wireless communication device.

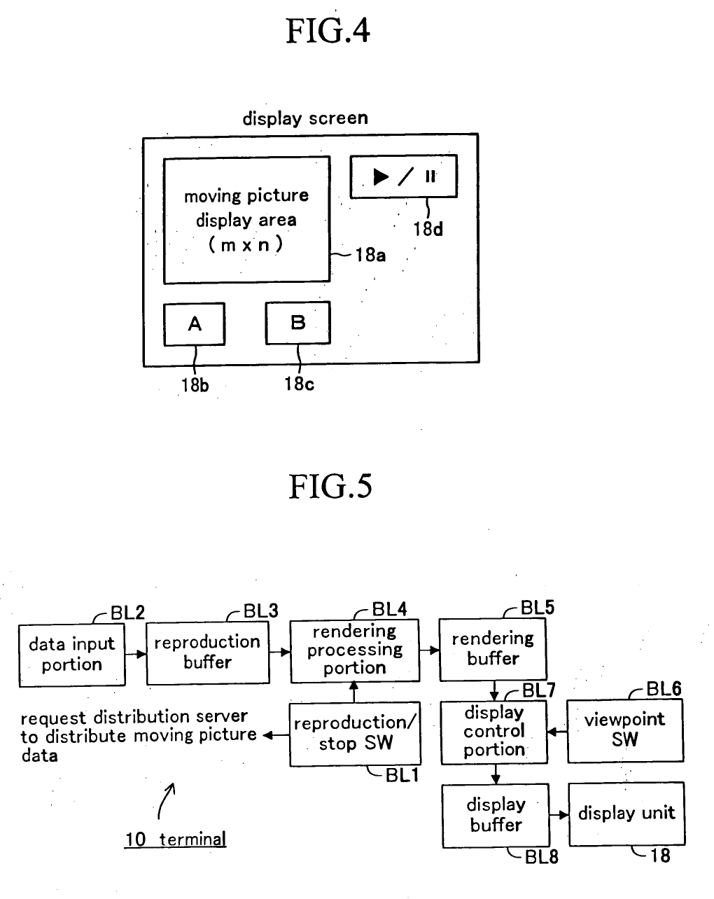

The tone generator 17 generates musical tone signals on the basis of performance data supplied under the control of the CPU 11, adds an effect to the generated musical tone signals and outputs the signals to a sound system 17a. The sound system 17a, which includes a speaker, an amplifier and the like, emits musical tones corresponding to the musical tone signals supplied from the tone generator 17. The display unit 18, which is composed of a liquid crystal display, a CRT or the like, contains a display control circuit for controlling display mode of its display screen. The display control circuit controls display mode of the display screen as shown in FIG. 4 to display on a moving picture display area 18a moving picture content in accordance with the m×n rendering data stored in the display buffer area of the RAM 13. An “A” button 18b and a “B” button 18cprovided in the display screen shown in FIG. 4 are display buttons for selecting a moving picture item viewed from viewpoints A and B, respectively. A play/stop mark 18d is a display button for starting or stopping reproduction of moving picture data. The input device 19 is composed of switch operators, volume operators, a cursor move operator (e.g., a mouse) and the like for inputting externally provided instructions. Particularly, clicking on the “A” button 18b, the “B” button 18c and the play/stop mark 18d shown in the display screen of FIG. 4 is done through the use of the cursor move operator.

Next explained will be operation of the embodiment configured as above. By executing a program which is not shown, a user operates the input device 19 to access the distribution server 30 through the communications interface circuit 16 and the network 20. After the access, the user operates the input device 19 to select moving picture data (content) that the user desires to load from the distribution server 30, referring to a menu screen displayed on the display unit 18. After the selection of content, the CPU 11 controls the display unit 18 to display. the “A” button 18b, the “B” button 18c and the play/stop mark 18d on the display screen and supply the moving picture display area 18a. If the user then operates the input device 19 to click the play/stop mark 18d, the CPU 11 requests the distribution server 30 to start distributing the selected moving picture data. Along with the request for distribution, the CPU 11 provides the reproduction buffer area in the RAM 13. In response to the request, the distribution server 30 streams the moving picture data through the network 20 to the communications interface circuit 16 of the terminal 10. The CPU 11 successively writes the moving picture data input through the communications interface circuit 16 into the reproduction buffer area provided in the RAM 13.

On requesting the distribution server 30 to start distributing the moving picture data, the CPU 11 starts executing the reproduction program shown in FIG. 3 at step S10. After the start of the reproduction program, the CPU 11 resets, at step S11, the rendering buffer area and the display buffer area in the RAM 13. At step S11, in other words, the CPU 11 provides the rendering buffer area (2×m×n) and the display buffer area (m×n) in the RAM 13, and clears data stored in the areas. At step S12, the CPU 11 then resets a viewpoint variable X to a value “A” for indicating an area “A” (an area which stores rendering data corresponding to the viewpoint “A”) of the rendering buffer area. The CPU 11 then starts repeatedly executing circulating processing formed of steps S13 to S19.

In the circulating processing, at step S13 the CPU 11 converts moving picture data corresponding to the first timing of the moving picture data written into the reproduction buffer area of the RAM 13 to rendering data, and writes the converted rendering data to the rendering buffer area in the RAM 13. In this case, written into the rendering buffer area is the rendering data of 2×m×n in which moving pictures of the received moving picture data for two panes on the viewpoints A and B are arranged in parallel (see FIG. 2A). Processes of steps S14 to S17 then allow a change to the viewpoint variable X in accordance with the user's operation on the input device 19. If either of the “A” button 18b and the “B” button 18c on the display screen of the display unit 18 have not been clicked, “no” is determined at step S14 to proceed to step S18 with the viewpoint variable X being kept at the previous value. If the “A” button 18b provided on the display screen has been clicked, “yes” is determined at step S14. Then, at step S15 as well, “yes” is determined to set the viewpoint variable X to a value “A” at step S16. The program then proceeds to step S18. If the “B”button 18c on the display screen has been clicked, “yes” is determined at step S14. Then, at step S15, “no” is determined to set the viewpoint variable X to a value “B” at step S17. The program then proceeds to step S18. Due to these steps, switching of the display of moving picture items between the viewpoints A and B is instructed.

At step S18, among the rendering data stored in the rendering buffer area of the RAM 13, the CPU 11 reads out the rendering data on the area “A” (area in which rendering data corresponding to the viewpoint “A” is stored) or the area “B” (area in which rendering data corresponding to the viewpoint “B” is stored) specified by the viewpoint variable X, and writes the read data into the display buffer area of the RAM 13. In this case, rendering data for one pane of the rendering data for two panes on the viewpoints A and B is written into the display buffer area (see FIG. 2B). Using the rendering data written into the display buffer area, the display unit 18 displays pictures corresponding to the rendering data on the moving picture display area 18a provided on the display screen. Unless a click operation on the play/stop mark 18d on the display screen is made by the input device 19, the program keeps determining “no” at step S19 to repeatedly perform the circulating processing formed of steps S13 through S19.

Then, due to the process of step S13, among the moving picture data written into the reproduction buffer area, moving picture data corresponding to a subsequent timing is successively converted to rendering data and written into the rendering buffer area of the RAM 13. Then, due to the process of step S18, among the rendering data stored in the rendering buffer area, rendering data corresponding to the area “A” or “B”specified by the viewpoint variable X is successively written into the display buffer area. On the basis of the rendering data written into the display 9 buffer area, pictures are successively displayed on the moving picture display area 18a. In accordance with the passage of time, therefore, moving picture content that is based on the moving picture data distributed by the distribution server 30 and corresponds to the specified viewpoint A or B is displayed on the moving picture display area 18a.

In a state where moving picture content is displayed as such, if the viewpoint variable X is changed through the processes of steps S14 to S16 by a click operation on the “A” button 18b or “B” button 18c, the rendering data to be written into the display buffer area is switched between the rendering data on the areas “A” and “B”, resulting in switching of moving picture items displayed on the moving picture display area 18a.

During the circulating processing formed of steps S13 through S19, if the user operates the input device 19 to click the play/stop mark 18d, the CPU 11 determines “yes” at step S19 to terminate the execution of the reproduction program at step S20. On terminating the execution of the reproduction program, the CPU 11 instructs the server 30 to stop distributing moving picture data. In response to the instruction, the distribution server 30 stops the distribution of moving picture data to the terminal 10. In addition to the instruction, the CPU 11 also clears moving picture data stored in the reproduction buffer area, the rendering buffer area and the display buffer area provided in the RAM 13.

Next, the terminal 10 configured and operating as described above will be explained with reference to a functional block diagram of FIG. 5. If a reproduction/stop switch BL1 requests the distribution server 30 to distribute moving picture data (equivalent to clicking on the play/stop mark 18d), the distribution server 30 distributes the moving picture data to the terminal 10. A data input portion BL2 (equivalent to the communications interface circuit 16) inputs the distributed moving picture data and successively writes the input data into a reproduction buffer BL3 (equivalent to the reproduction buffer area provided in the RAM 13). A rendering processing portion BL4 successively loads the moving picture data from the reproduction buffer BL3 and writes the moving picture data including rendering data for two panes into a rendering buffer BL5 (equivalent to the rendering buffer area provided in the RAM 13).

The user operates a viewpoint switch BL6 to select either of the viewpoints A and B (equivalent to clicking on the button “A” 18b or “B” 18c). A display control portion BL7 extracts a pane of rendering data on the viewpoint A or viewpoint B selected by use of the viewpoint switch BL 6 from the two panes of rendering data on the viewpoints A and B stored in the rendering buffer BL5, and writes the extracted data into a display buffer BL8 (equivalent to the display buffer area provided in the RAM 13). The display unit 18 displays picture content in accordance with the rendering data stored in the display buffer BL8. The writing of moving picture data into the reproduction buffer BL3 and the writing of rendering data into the rendering buffer BL5 and the display buffer BL8 are performed successively, resulting in moving picture content being displayed on the display unit 18 in accordance with the passage of time.

In the state where moving picture content is displayed on the display unit 18 as such, furthermore, if switching of the viewpoints is instructed by use of the viewpoint switch BL6, rendering data to be written into the display buffer BL8 is switched between rendering data on the viewpoints A and B, resulting in moving picture content to be displayed on the display unit 18 also being switched.

On the terminal 10 that operates as described above, an instruction to switch moving picture data sets for display viewed from various viewpoints causes switching of rendering data to be written from the rendering buffer BL5 (the rendering buffer area provided in the RAM 13) into the display buffer BL8 (the display buffer area provided in the RAM 13). Since rendering data written in the rendering buffer BL5 is moving picture data in which moving picture items seen from the viewpoints A and B are synchronized, and switching of rendering data to be written into the display buffer BL8 causes switching of moving picture items to be displayed on the display unit 18, the terminal 10 easily enables synchronized switching of the viewpoints of the two moving picture items, keeping continuity of the moving picture content. As a result, in a case where a model performance of a musical instrument is shown as moving picture content, for example, the user is allowed to variously observe the model performance of a player of the musical instrument, freely switching pictures of the whole body and body parts of the player.

In carrying out the present invention, furthermore, it will be understood that the present invention is not limited to the above-described embodiment, but various modifications may be made without departing from the spirit and scope of the invention.

For instance, although descriptions about the above embodiment do not include detailed description on the format of moving picture data distributed from the distribution server 30, any format can be employed as far as the terminals 10 can support.

In the above embodiment, furthermore, two moving picture data sets are distributed from the distribution server 30 to the terminal 10, and the terminal 10 selectively switches the two moving picture data sets and displays either of the moving picture items. Instead of the above embodiment, however, three or more moving picture data sets may be combined into one moving picture data set to distribute from the distribution server 30 to the terminal 10, and the terminal 10 may selectively switch the three or more moving picture data sets and display moving picture content corresponding to any one of the moving picture data sets. In the above embodiment, in addition, the display unit 18 displays one moving picture item. However, the display unit 18 may simultaneously display a plurality of moving picture items based on a plurality of moving picture data sets. In this modification, the terminal 10 may be designed to switch all the moving picture items displayed on the display unit 18 at one time or to switch any one of or a plurality of displayed moving picture items.

In the above embodiment, furthermore, moving picture data is previously stored in the database 31 of the distribution server 30, and the moving picture data stored in the database 31 is distributed to the terminals 10. Instead of or in addition to the above, however, a plurality of moving picture data sets representative of moving picture items viewed from various viewpoints and taken in real time may be combined into one moving picture data set to be distributed from the distribution server 30 to the terminal 10.

What is claimed is:

1. A terminal for receiving externally distributed picture data and displaying, on a display unit, picture content represented by the received picture data, the terminal comprising:
an inputting portion for inputting streamed moving picture data in which a plurality of moving picture data sets respectively representative of moving picture items shot from respectively different viewpoints are combined;
a data converter for successively converting the input moving picture data to rendering data for rendering on the display unit, and temporarily storing the converted data;
a viewpoint selector for selecting at least one of the viewpoints; and
a display controller for retrieving, from the temporarily stored rendering data, rendering data corresponding to the viewpoint selected by the viewpoint selector, and temporarily storing for use in display on the display unit, thereby displaying picture content corresponding to the rendering data on the selected viewpoint on the display unit.

2. A terminal according to claim 1, wherein the picture content is a model performance of a player of a musical instrument.

3. A terminal according to claim 2, wherein the picture content includes pictures of the whole body and body parts of the player.

4. A terminal according to claim 1, further receiving automatic performance data.

5. A computer program applied to a terminal having a receiving portion for receiving externally distributed picture data, a display portion for displaying picture content represented by the picture data, an instruction inputting portion for inputting a user's instruction, and a memory device, and including a computer portion for executing the computer program, the computer program causing the computer portion to perform the processes of:
causing the receiving portion to input streamed moving picture data in which a plurality of moving picture data sets respectively representative of moving picture items shot from respectively different viewpoints are combined;
successively converting the input moving picture data to rendering data for rendering on the display unit, and writing the converted data into a rendering data storage buffer provided in the memory device;
inputting, from the instruction inputting portion, an instruction for selecting at least one of the viewpoints; and
retrieving, from the rendering data written into the rendering data storage buffer, rendering data on viewpoint selected by the input instruction, and writing the retrieved rendering data into a display data storage buffer provided in the memory device for use in storing display data representative of picture content to be displayed on the display unit.

6. A computer program according to claim 5, wherein the picture content is a model performance of a player of a musical instrument.

7. A computer program according to claim 6, wherein the picture content includes pictures of the whole body and body parts of the player.

8. A computer program according to claim 5, wherein the terminal further receives automatic performance data.
